(19) United States
(12) Patent Application Publication
(10) Pub. No.: US 2011/0103872 A1
(43) Pub. Date: May 5, 2011

(54) MULTIPLE CONTAINER FOR NAIL COSMETICS

(76) Inventor: Kee Won CHOI, Seoul (KR)

(21) Appl. No.: 12/608,095

(22) Filed: Oct. 29, 2009

(51) Int. Cl. B43K 27/00

(52) U.S. Cl. 401/34

(57) ABSTRACT

The multiple container for nail cosmetics includes at least two cosmetic containers to receive nail cosmetic liquids, and the at least two cosmetic containers are detachably installed at both sides of the multiple container via a connection member, respectively. The at least two cosmetic containers include a first container and a second container. The lower portion of the first container is installed at the upper portion of the connection member, and the upper portion of the second container is installed at the lower portion of the connection member. Thereby, the multiple container for nail cosmetics is easy to carry, and is capable of containing several kinds of cosmetics in one product. Further, when one cosmetic container is desired to be used, the cosmetic container is separated from the connection member and thus is light and conveniently used.

### BACKGROUND OF THE INVENTION

1. Field of the Invention

The present invention relates to a container for nail cosmetics, and more particularly to a multiple container for nail cosmetics having a connection member connecting at least two cosmetic containers.

2. Description of the Related Art

In general, nail cosmetics serve to protect nails and decorate nails. Such nail cosmetics include topcoat and enamel accommodated in a container, and are used with a brush or a tip coated therewith.

Most conventional containers for nail cosmetics were used with a brush coated with cosmetic. Now, such nail cosmetics are not used to simply apply colors to nails, but are widely used to perform nail art expressing a design, such as a pattern or a sketch, on nails. Therefore, in order to perform the above-described nail art, brushes and pens of various kinds as well as various-colored nail cosmetics are required, thus causing cumbersomeness. This problem is caused because one container is generally provided with one kind of brush or pen.

Further, in order to use various colors, a user needs to have various-colored nail cosmetics. Particularly, in a nail shop, many nail cosmetics need to be provided in spite of frequent change of preferred colors or trends.

Particularly, if a user carrying nail cosmetics wishes to use different colors, the user needs to carry a large number of the nail cosmetics since the nail cosmetics are respectively accommodated in different containers according to colors and kinds of the nail cosmetics, thereby lowering portability of the nail cosmetics and increasing volume of user's belongings.

Further, if a user grips a container for nail cosmetics with a pen to perform nail art, the heavy load of the container made of glass and located at the rear of the pen hinders user's free movement and increases user fatigue or prevents the user from expressing a desired design.

Moreover, since the container for nail cosmetics made of glass has a heavy weight, if a user carries a large number of nail cosmetics, a user's handbag is heavy and the container for nail cosmetics may be damaged due to user carelessness.

### SUMMARY OF THE INVENTION

Therefore, the present invention has been made in view of the above problems, and it is an object of the present invention to provide a multiple container for nail cosmetics, into which at least two cosmetic containers are integrated by a connection member.

It is a further object of the present invention to provide a multiple container for nail cosmetics, which causes cosmetic containers to be connected to both sides thereof via a connection member.

It is another object of the present invention to provide a multiple container for nail cosmetics, in which a connection member is detachably connected to cosmetic containers.

It is another object of the present invention to provide a multiple container for nail cosmetics, in which a cover part to cover a cosmetic container is detachably connected to the cosmetic container provided with an upper portion connected to a connection member.

It is another object of the present invention to provide a multiple container for nail cosmetics, in which cosmetic containers having a light weight are formed.

It is another object of the present invention to provide a multiple container for nail cosmetics, in which cosmetic containers are flexibly formed.

It is yet another object of the present invention to provide a multiple container for nail cosmetics, in which one cosmetic container is provided with various applying members.

In accordance with the present invention, the above and other objects can be accomplished by the provision of a multiple container for nail cosmetics including at least two cosmetic containers to receive nail cosmetic liquids, the at least two cosmetic containers being detachably installed at both sides of the multiple container via a connection member, respectively.

The at least two cosmetic containers may include a first container and a second container, and the lower portion of the first container may be installed at the upper portion of the connection member, and the upper portion of the second container may be installed at the lower portion of the connection member.

An upper connection part and a lower connection part respectively corresponding to a first connection part of the first container and a second connection part of the second container may be formed at the upper portion and the lower portion of the connection member.

The upper connection part and the lower connection part may include screw threads formed respectively corresponding to the first connection part and the second connection part.

The upper connection part and the lower connection parts may include connection grooves or connection protrusions formed respectively corresponding to the first connection part and the second connection part.

The connection member may be provided with a cover connection part, to which a cover of the second container is connected.

The at least two cosmetic containers may be made of a synthetic resin.

A push recess may be formed on the outer surface of at least one of the at least two cosmetic containers.

The multiple container for nail cosmetics may further include a first cover part, to cover the first container, provided with one side, at which an applying member accommodated in the first container to apply cosmetic contained in the first container to nails is installed, and the other side, at which a subsidiary applying member communicated with a supply channel so as to receive the cosmetic contained in the first container and apply the cosmetic to nails is installed.

The applying member and the subsidiary applying member may be formed in different types.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view of a multiple container for nail cosmetics in accordance with one embodiment of the present invention;

FIG. 2 is a partially exploded perspective view of the multiple container for nail cosmetics in accordance with the embodiment of the present invention;

FIG. 3 is an exploded longitudinal-sectional view of the multiple container for nail cosmetics in accordance with the embodiment of the present invention;

FIGS. 4A to 4E are views respectively illustrating connection parts of a connection member and first and second containers in accordance with the embodiment of the present invention;

FIG. 5 is an exploded longitudinal-sectional view of a multiple container for nail cosmetics in accordance with another embodiment of the present invention;

FIGS. 6A to 6E are views respectively illustrating connection parts of a connection member and first and second containers in accordance with the embodiment of the present invention;

FIG. 7 is an exploded longitudinal-sectional view of a multiple container for nail cosmetics in accordance with yet another embodiment of the present invention;

FIG. 8 is a view illustrating use of a tube of the multiple container for nail cosmetics in accordance with the embodiment of the present invention;

FIG. 9 is a view illustrating use of a first brush of the multiple container for nail cosmetics in accordance with the embodiment of the present invention; and

FIG. 10 is a view illustrating use of a second brush of the multiple container for nail cosmetics in accordance with the embodiment of the present invention.

### DETAILED DESCRIPTION OF THE INVENTION

Hereinafter, preferred embodiments of the present invention will be described in detail with reference to the annexed drawings.

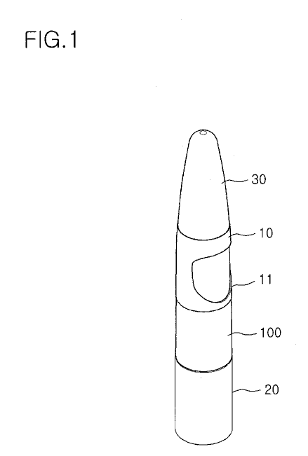

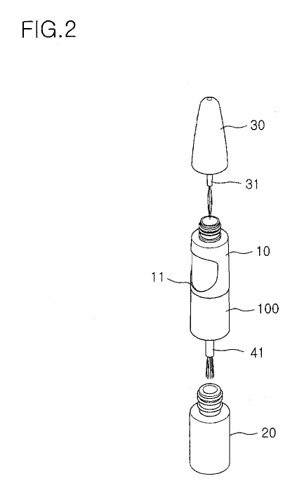

FIG. 1 is a perspective view of a multiple container for nail cosmetics in accordance with one embodiment of the present invention, and FIG. 2 is a partially exploded perspective view of the multiple container for nail cosmetics in accordance with this embodiment.

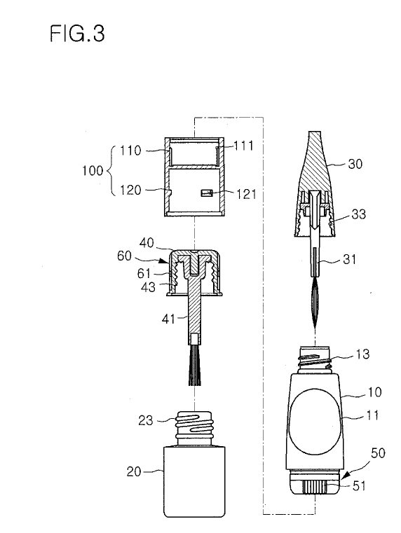

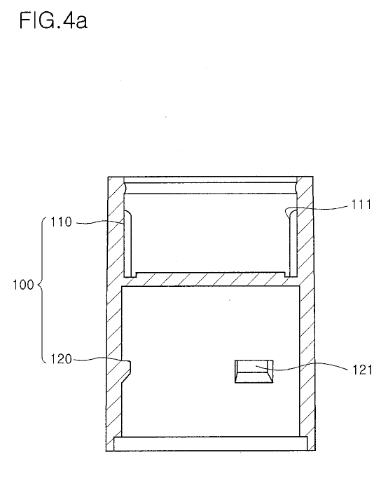

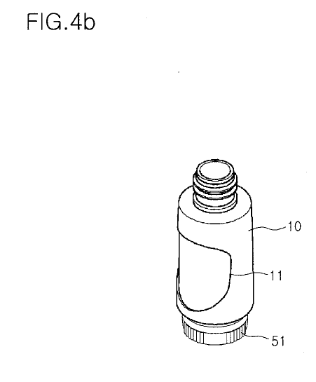

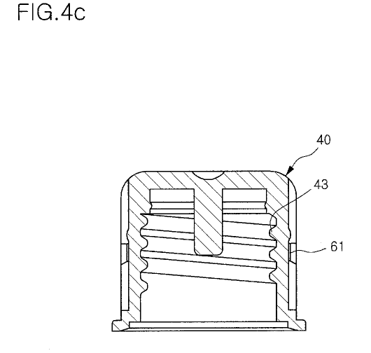

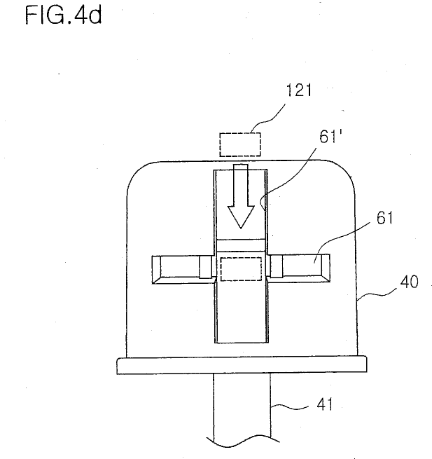

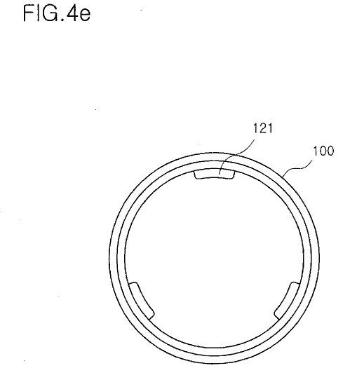

FIG. 3 is an exploded longitudinal-sectional view of the multiple container for nail cosmetics in accordance with this embodiment, and FIGS. 4A to 4E are views respectively illustrating connection parts of a connection member and first and second containers in accordance with this embodiment.

As shown in FIGS. 1 to 4E, the multiple container for nail cosmetics in accordance with this embodiment includes a first container 10, a second container 20, and a connection member 100 to connect the first container 10 and the second container 20.

Preferably, the first container 10, the second container 20, and the connection member 100 are made of a synthetic resin so that the multiple container for nail cosmetics is lightweight when the first and second containers 10 and 20 are filled with cosmetics.

With reference to FIG. 2, the first container 10 is connected to the upper portion of the connection member 100, and a first container cover 30 provided with a first brush 31 to apply cosmetic, accommodated in the first container 10, to nails is installed on the upper surface of the first container 10.

Further, the second container 20 is connected to the lower portion of the connection member 100, and a second container cover 40 provided with a second brush 41 to apply cosmetic, accommodated in the second container 20, to nails is preferably connected to the lower portion of the connection member 100. Here, the upper portion of the connection member 100 is connected to the lower portion of the first container 10, and the lower portion of the connection member 100 is connected to the upper portion of the second container 20.

In more detail, with reference to FIG. 3, the connection member 100 includes a first connection part 110 provided with the upper portion, to which the first container 10 is connected, and a second connection part 120 provided with the lower portion, to which the second container cover 40 of the second container 20 is connected.

Therefore, an upper connection part 50 having an outer diameter, which can be inserted into the first connection part 110, is formed on the lower portion of the first container 10, and a lower connection part 60, which causes the second container cover 40 to be inserted into the second connection part 120, is formed on the outer surface of the second container cover 40 of the second container 20.

Of course, the connection member 100 and the first and second containers 10 and 20 may be attached to and detached from each other through the first and second connection parts 110 and 120 and the upper connection part 50 and the lower connection part 60.

Here, the first and second connection parts 110 and 120 and the upper connection part 50 and the lower connection part 60 may include connection grooves and connection protrusions.

In more detail, the first connection part 110 and the second connection part 120 of the connection member 100 may respectively include upper connection protrusions 111 and lower connection protrusions 121, as shown in FIG. 4A.

With reference to FIG. 4B, the upper connection part 50 of the first container 10 may include upper connection grooves 51 formed corresponding to the upper connection protrusions 111, and with reference to FIG. 4C, the lower connection part 60 of the second container cover 40 may include lower connection grooves 61 formed corresponding to the lower connection protrusions 121.

Preferably, the upper connection grooves 51 and the upper connection protrusions 111 are connected by press fit. Further, a push recess 11 is formed on the outer surface of the first container 10 made of a synthetic resin, and thus is pressed when the first container 10 is connected to and disconnected from the connection member 100, so as to induce deformation of the upper connection part 50, thereby facilitating connection and disconnection between the upper connection grooves 51 and the upper connection protrusions 111.

A first container male screw 13 is formed on the upper portion of the first container 10, and a first container female screw 33 corresponding to the first container male screw 13 is formed on the inner surface of the first container cover 30, thereby allowing the first container cover 30 to be connected to or to be disconnected from the first container 10 during use.

With reference to FIGS. 4D to 4E, in addition to the lower connection grooves 61, guide grooves 61′ to guide the lower connection protrusions 121 is further formed on the outer surface of the second container cover 40.

Therefore, the lower connection protrusions 121 are inserted into the guide grooves 61′ of the second container cover 40, thereby causing the second container cover 40 to come into the lower connection part 120 of the connection member 100. Thereafter, the lower connection protrusions 121 of the connection member 100 are inserted into the lower connection grooves 61 of the second container cover 40 by rotating the second container cover 40, thereby fixing the position of the second container cover 40 connected to the connection member 100 and connecting the connection member 100 and the second container 30, simultaneously.

A second container male screw 23 is formed on the upper portion of the second container 20, and a second container female screw 43 corresponding to the second container male screw 23 is formed on the inner surface of the second container cover 40, thereby allowing the second container cover 40 to be connected to or to be disconnected from the second container 20 during use.

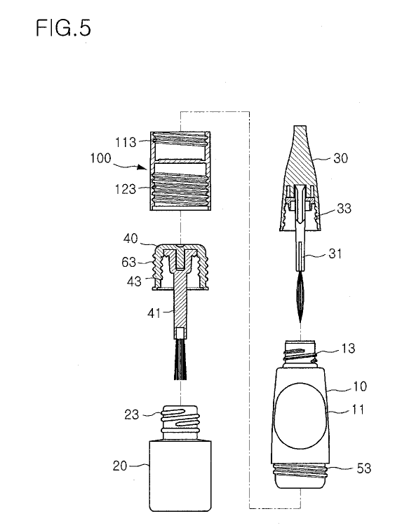

FIG. 5 is an exploded longitudinal-sectional view of a multiple container for nail cosmetics in accordance with another embodiment of the present invention.

As shown in FIG. 5, first and second connection parts 50 and 60 of first and second containers 10 and 20, and an upper connection part 110 and a lower connection part 120 of a connection member 100 may include screw threads.

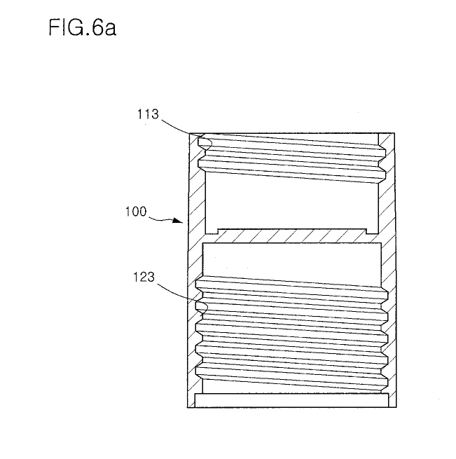

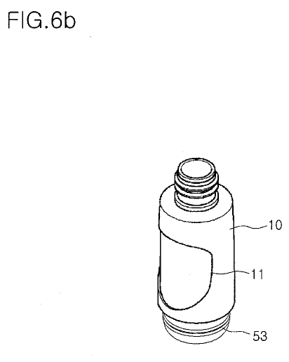

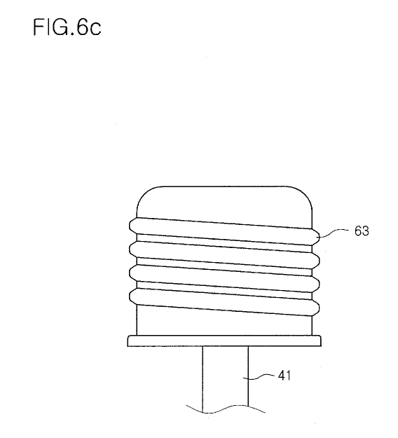

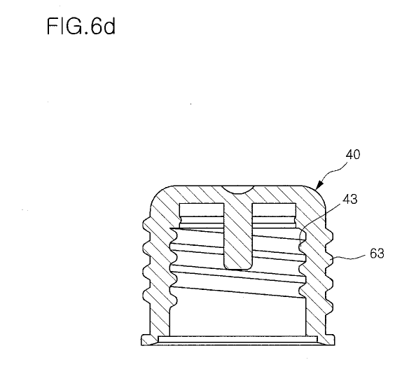

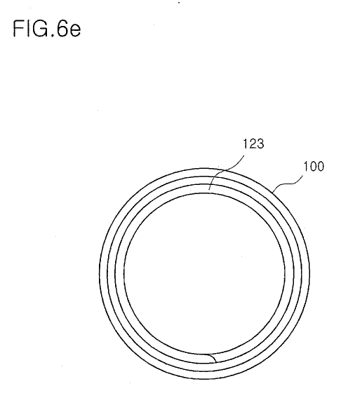

In more detail, as shown in FIG. 6A, the upper connection part 110 of the connection member 100 includes an upper screw thread 113, and the lower connection part 120 of the connection member 100 includes a lower screw thread 123. Further, the first connection part 50 of the first container 10 includes a first screw thread 53 corresponding to the upper screw thread 113, as shown in FIG. 6B, and the second connection part 60 formed on the outer surface of the second container cover 40 includes a second screw thread 63 corresponding to the lower screw thread 123, as shown in FIG. 6C to 6E.

Accordingly, the first container 10 and the second container 20 are connected to and disconnected from the connection member 100 by the screw threads. Particularly, by rotating the second container 20, the second container 20 may be connected to and disconnected from the second container cover 40 as well as may be connected to and disconnected from the connection member 100.

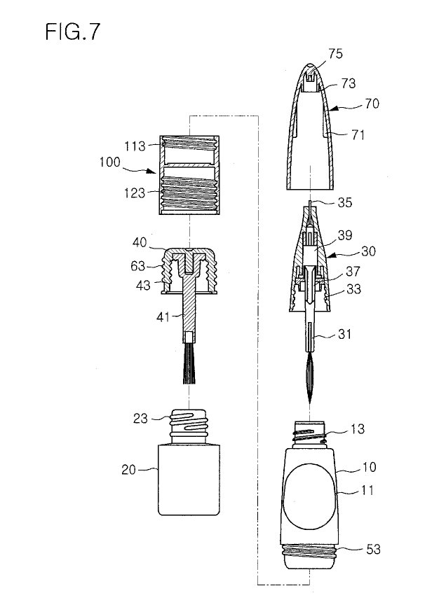

FIG. 7 is an exploded longitudinal-sectional view of a multiple container for nail cosmetics in accordance with yet another embodiment of the present invention.

As shown in FIG. 7, a first container 10 is provided with a first container cover 30 provided with a first brush 31. A channel 37, which causes cosmetic to flow along the first brush 31, and a reception hole 39 to temporarily accommodate the flowing cosmetic are formed at one side of the first container cover 30, on which the brush 31 is installed.

Further, a thin tube 35 communicated with the reception hole 39 is installed at one side of the reception hole 39, opposite to the first brush 31.

The tube 35 has a small inner diameter so as to express a fine line in a design, which is desired to be represented by a user.

A subsidiary cover 70 is provided on the tube 35. The subsidiary cover 70 includes a tube closing member 75 surrounding the outer diameter of the tube 35 so as to close an opening of the tub 35, and a tube guide member 73 surrounding the outer surface of the upper portion of the first container cover 30 and guiding the tube 35 to the tube closing member 75.

Preferably, a guide connection protrusion 71, which prevents damage to the tube 35 and contacts the outer surface of the first container cover 30 to connect the subsidiary cover 70 to the first container cover 30, is formed on the inner surface of the subsidiary cover 70.

Hereinafter, use of the above multiple container for nail cosmetics in accordance with this embodiment will be described in detail.

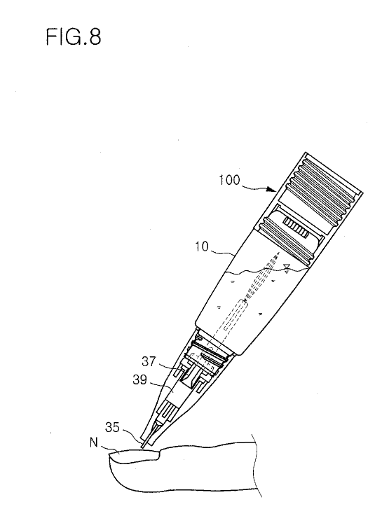

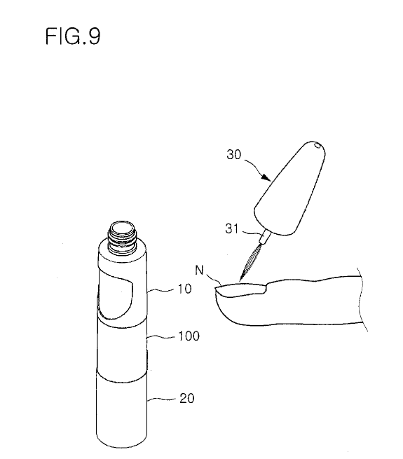

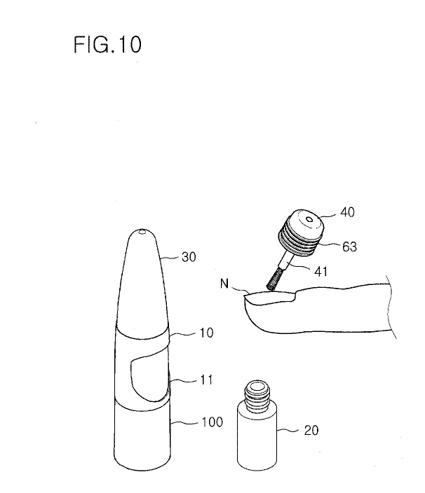

FIG. 8 is a view illustrating use of the tube of the multiple container for nail cosmetics in accordance with this embodiment, FIG. 9 is a view illustrating use of the first brush of the multiple container for nail cosmetics in accordance with this embodiment, and FIG. 10 is a view illustrating use of the second first brush of the multiple container for nail cosmetics in accordance with this embodiment.

With reference to FIG. 8, when a user wishes to use the tube 35, the user separates the first connection part 50 provided at the lower portion of the first container 10 from the upper connection part 110 of the connection member 100, or separates the second container cover 40 of the second container 20 from the connection member 100.

Thereafter, the user separates the subsidiary cover 70 from the first container cover 30.

Next, the user tilts the first container 10 such that the lower portion of the first container 10 faces upward. Thereby, cosmetic contained in the first container 10 moves to the reception hole 39 through the channel 37 formed along the first brush 31.

The cosmetic in the reception hole 39 is discharged to the outside of the container through the opening of the tube 35, and is applied to a nail N, thereby being used to express a subtle design.

Here, the second container 20 may not be separated from the first container 10. However, if the user uses the tube 35 to apply cosmetic to the nail N under the condition that the second container 20 is separated from the first container 10, the overall weight of the container is reduced and the user may express a more subtle design.

As shown in FIG. 9, when a user wishes to use the first brush 31, the user separates the first container cover 30 from the first container 10, and applies cosmetic to a nail N using the first brush 31 installed on the first container cover 30.

As shown in FIG. 10, when a user wishes to use the second brush 41, the user separates the second container 60 from the connection member 100 and the first container 10 by separating the second connection part 60 formed on the outer surface of the second container cover 40 from the lower connection part 120 of the connection member 100.

Next, the user separates the second container cover 40 from the second container 20 in the same manner as a general container for nail cosmetics, and then applies cosmetic to a nail N using the second brush 41 of the second container cover 40.

Therefore, the above-described multiple container for nail cosmetics, in which the respective containers 10 and 20 are detachably connected by the connection member 100, uses different kinds of cosmetics and applying members in one product, and is light and conveniently used.

As apparent from the above description, the multiple container for nail cosmetics in accordance with the present invention is obtained by connecting at least two cosmetic containers by a connection member, thereby being easy to carry and being capable of containing several kinds of cosmetics in one product.

Further, since at least two cosmetic containers are detachably connected to the connection member, when a user wishes to use cosmetic in one cosmetic container, the user separates the cosmetic container from the connection member and then uses the cosmetic, and after use, the user re-connects the cosmetic container to the connection member so that the multiple container may be portable.

Further, since the cosmetic containers are made of a synthetic resin, the multiple container for nail cosmetics is lightweight, thereby being capable of expressing a subtle design as well as reducing user fatigue and being simply used.

Further, since the push part is formed on the outer surface of the cosmetic container made of the synthetic resin, the connection and disconnection between the cosmetic container and the connection member is facilitated by simply pressing the push part on the outer surface of the cosmetic container.

Further, since one cosmetic container is provided with different kinds of applying members, the cosmetic in the cosmetic container is applied to nails by various methods, thereby being capable of expressing various designs.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A multiple container for nail cosmetics comprising at least two cosmetic containers to receive nail cosmetic liquids, the at least two cosmetic containers being detachably installed at both sides of the multiple container via a connection member, respectively.

2. The multiple container for nail cosmetics according to claim 1, wherein:
the at least two cosmetic containers include a first container and a second container; and
the lower portion of the first container is installed at the upper portion of the connection member, and the upper portion of the second container is installed at the lower portion of the connection member.

3. The multiple container for nail cosmetics according to claim 2, wherein an upper connection part and a lower connection part respectively corresponding to a first connection part of the first container and a second connection part of the second container are formed at the upper portion and the lower portion of the connection member.

4. The multiple container for nail cosmetics according to claim 3, wherein the upper connection part and the lower connection part include screw threads formed respectively corresponding to the first connection part and the second connection part.

5. The multiple container for nail cosmetics according to claim 3, wherein the upper connection part and the lower connection parts include connection grooves or connection protrusions formed respectively corresponding to the first connection part and the second connection part.

6. The multiple container for nail cosmetics according to claim 2, wherein the connection member is provided with a cover connection part, to which a cover of the second container is connected.

7. The multiple container for nail cosmetics according to claim 1, wherein the at least two cosmetic containers are made of a synthetic resin.

8. The multiple container for nail cosmetics according to claim 7, wherein a push recess is formed on the outer surface of at least one of the at least two cosmetic containers.

9. The multiple container for nail cosmetics according to claim 2, further comprising a first cover part, to cover the first container, provided with one side, at which an applying member accommodated in the first container to apply cosmetic contained in the first container to nails is installed, and the other side, at which a subsidiary applying member communicated with a supply channel so as to receive the cosmetic contained in the first container and apply the cosmetic to nails is installed.

10. The multiple container for nail cosmetics according to claim 9, wherein the applying member and the subsidiary applying member are formed in different types.
